(19) United States
(12) Patent Application Publication
(10) Pub. No.: US 2025/0286656 A1
(43) Pub. Date: Sep. 11, 2025

(54) Neural network-based decoder architecture for 5G

(71) Applicant: Indian Institute of Technology Madras (IIT Madras), Chennai (IN)

(72) Inventors: Radhakrishna Ganti, Chennai (IN); Jeeva Keshav Sattianarayanin, Chennai (IN); Anil Kumar Yerrapragada, Chennai (IN)

(21) Appl. No.: 19/073,480

(22) Filed: Mar. 7, 2025

(30) Foreign Application Priority Data
Mar. 7, 2024 (IN) 202441016642

(51) Int. Cl. H04L 1/00; G06F 18/2431; G06N 3/082; H04L 1/1812; H04L 41/16; H04W 72/21

(52) U.S. Cl. CPC H04L 1/0073; G06F 18/2431; G06N 3/082; H04L 1/1812; H04L 41/16; H04W 72/21

(57) ABSTRACT

The invention discloses systems and methods for decoding sequence based feedback signaling in wireless communication. The system comprises a plurality of User Equipment (UE) and the base station configured for establishing wireless communication links. The base station includes a multi-label neural network classifier configured to decode the signals. The method for decoding the wireless communication includes the steps of: providing the multi-label neural network classifier, generating training datasets and training the network using same equipment as used for communication or any other system. The method involves receiving the input PUCCH Format 0 signal, and predicting the N_{UE} phase rotations a using the neural network. The α values are used to map back with the UCI-specific cyclic shift m_{cs} for each UE. The system and method outperform conventional DFT-based decoders across all SNR ranges and dopplers and are robust enough to identify false transmissions, thus eliminating the need for thresholds.

### CROSS-REFERENCES TO RELATED APPLICATION

This application claims priority to Indian provisional patent application No. 20/244,1016642 entitled NEURAL NETWORK-BASED DECODER ARCHITECTURE FOR 5G filed on Mar. 7, 2024.

### FIELD OF THE INVENTION

The invention generally relates to wireless communication and in particular to receiver for wireless communications.

### DESCRIPTION OF THE RELATED ART

Accurate decoding of Uplink Control Information (UCI) on the Physical Uplink Control Channel (PUCCH) is essential for enabling 5G wireless links. This invention proposes an AI/ML-based receiver design for PUCCH Format 0. Format 0 signaling encodes the UCI content within the phase of a known base waveform and even supports multiplexing of up to 12 users within the same time-frequency resources. Our first-of-a kind neural network classifier, which we term UCINet0, is capable of predicting when no user is transmitting on the PUCCH, as well as decoding the UCI content of any number of multiplexed users, up to 12. Inference results with both simulated and hardware captured field datasets show that the UCINet0 model outperforms conventional DFT based decoders across all SNR and doppler ranges. In our invention, we show the best possible input output combination that enables neural network based PUCCH Format 0 decoding.

In order to encompass the wide range of capacity and latency requirements of various 5G applications, as illustrated in FIG. 2A, the 5G standards have provisioned five different formats of the PUCCH transmission. Smaller UCI payloads of 1 or 2 HARQ bits and/or an SR are transferred using Formats 0 and 1. Larger payloads, including several SR and HARQ bits, along with CSI reports, are transmitted using Formats 2, 3, and 4. Furthermore, Formats 0 and 2 are suitable for low latency applications since they occupy only 1 or 2 OFDM symbols in the time domain. Formats 1, 3, and 4 are suitable for applications requiring improved coverage and capacity since they extend between 4 and 14 OFDM symbols in the time domain and provide SNR gain.

PUCCH Format 0 is used to transfer one or two HARQ acknowledgments and/or an SR. In 5G, Format 0 signalling is used as early as the initial attach procedure in which a UE is trying to latch onto a gNB. During the initial attach, there are several critical downlink transmissions, such as the Radio Resource Control (RRC) Setup, that need to be acknowledged, which the UE signals on PUCCH Format 0. It is to be noted that at this early stage of the connection process, neither the UE nor the gNB are expected to have obtained detailed information about the wireless surroundings. Consequently, Format 0 employs a sequence-based transmission in which phase-rotated versions of a pre-defined base sequence are transmitted by the UE. The UCI is encoded in the phase of the base sequence. Since the base sequence is assumed to be known at both ends, Format 0 signalling does not contain any pilot reference signals such as the Demodulation Reference Signals (DMRS), nor does it use Quadrature Amplitude Modulation (QAM) to modulate the UCI bits.

### SUMMARY OF THE INVENTION

The invention discloses systems (100) and methods (200) for decoding the feedback signaling in wireless communication. The system (100) comprises a plurality of User Equipment (UE) (101) configured to receive at least one downlink transmission. Each such downlink transmission (102) needs to be acknowledged by the UE by signals on the PUCCH Format 0. The base station (104) is configured to receive the Uplink Control Information (UCI) carried by the PUCCH (103), for decoding. In various embodiments, the base station (104) comprises a multi-label neural network classifier (UCINet0) (105) for downlink transmission (102) which is to be received by a UE.

In various embodiments, the multi-label neural network classifier (UCINet0) (105) comprises an input layer (1051) containing 12 or more neurons configured to receive 12 or more real or complex sequence inputs, or 24 neurons configured to receive 24 real sequence inputs, and an additional optional input for metadata. The classifier further includes one or more dense layers (1052) containing 64 or more neurons, an output layer (1053) containing 12 or more neurons representing up to 12 phase rotation (a) values of the multiplexed users.

The invention in its various embodiments discloses a method (200) for decoding the UCI, communicated wirelessly. The method (200) includes the steps of: providing (201) the multi-label neural network classifier (105) to serve as a generalized PUCCH Format 0 decoder. Further steps include generating (202) the datasets from simulation tools or real-time-over-the-air or both, for training the decoding model. The neural network is then trained (203) with multiple epochs, using data with one or more SNRs (for example, a median SNR). 75% of the data may be used for training, from which a further 30% may be used for validation and fine-tuning (204) of hyper-parameters. Then, the input PUCCH Format 0 signal and associated metadata are received (205). In some embodiments, the signal may be pre-processed and fed (206) to the decoding model. Finally, the method involves predicting (207) the N_{UE} phase rotation values α₀, α₁ . . . αN_{UE}−1 applied to the base sequence for classification. The α values are used (208) to map back with the UCI-specific cyclic shift m_{cs} for each UE.

In various embodiments, providing (201) the multi-label neural network classifier comprises providing the input layer (1051) containing 12 or more neurons configured to receive 12 or more real or complex sequence inputs or 24 neurons configured to receive 24 real sequence inputs and an additional optional input for metadata. The method may involve providing one or more dense layers (1052) containing 64 or more neurons. The output layer (1053) may contain 12 or more neurons representing up to 12 phase rotation (α) values of the multiplexed users.

In some embodiments, providing (201) the multi-label neural network classifier comprises providing an input layer (1051) containing 25 neurons configured to receive 24 real sequence inputs and metadata as 25^{th} input. The method then comprises using three dense layers (1052) each containing 256 neurons as middle layers. The output layer (1053) may contain 12 neurons configured to receive up to 12 phase rotation (α) values of the multiplexed users.

In various embodiments, the method (200) involves generating (202) the datasets for training (203) the decoding model, by collecting and storing (301) waveform samples generated in a simulation software environment. Alternatively, the datasets for training may be generated by collecting and storing (302) real time received signal waveform samples from a live communication link. Further steps for training (203) the decoding model include running (303) multiple epochs of training wherein each epoch is 1 pass of the entire training dataset through the decoding model. The summation of waveforms resulting from multiplexed transmission is then used (304) by multiple transmitting entities. Further, the method may comprise using (305) selected data conforming to a single or multiple value(s) of SNR. The training may also involve dropouts (306) of randomly selected neurons and their connections with a certain probability during training. In various embodiments, the training (203) may take place on a same hardware on which the method is deployed, or on a different system.

In various embodiments, testing (204) the decoding model includes providing upper bound value of the number of multiplexed users as the metadata input which is offset from the true value. The prediction (207) may comprise determining the N_{UE} phase rotation values α₀, α₁ . . . .αN_{UE}−1 applied to the base sequence for classification. The method may involve obtaining (208) either a single α value, multiple α values, or zero α values.

In various embodiments, during early stage of the connection process, neither the UE nor the gNB are expected to have obtained detailed information about the wireless surroundings. Generating (202) the dataset for training may include operating the transmitter or the receiver or both in a specific data collection mode to generate specific training sequences. The preprocessing (206) may comprise using one of Fourier Transform, correlation, scaling or absolute value squared to the input signal.

In various embodiments, receiving Uplink Control Information (UCI) carried by the PUCCH (205) at the base station may include Hybrid Automatic Repeat Request (HARQ) acknowledgements for prior downlink transmissions, Scheduling Request (SR) for the subsequent allocation of uplink transmission resources, or Channel State Information (CSI) reports including channel quality metrics that facilitate link adaptation, precoding, and downlink resource allocation.

This and other aspects are disclosed herein.

### BRIEF DESCRIPTION OF THE DRAWINGS

The invention has other advantages and features, which will be more readily apparent from the following detailed description of the invention and the appended claims, when taken in conjunction with the accompanying drawings, in which:

FIG. 1A illustrate the system for feedback signaling in wireless communication.

FIG. 1B illustrate the UCINet0 Architecture for PUCCH Format 0.

FIG. 2A illustrate the method for decoding the UCI wireless communication.

FIG. 2B shows the steps for generating dataset and training the decoding model.

FIG. 3A-3C illustrate the example scenarios showing how assigning different initial cyclic shifts to different UEs allows them to be multiplexed on the same time-frequency resources.

FIG. 4A illustrates the output of correlation of received Format 0 signal with the known base sequence for 1 UE transmission

FIG. 4B illustrates the output of correlation of received Format 0 signal with the known base sequence for 3 UEs multiplexed transmission.

FIG. 5 shows the IIT-Madras 5G testbed setup with the Remote Radio Head used as a receiver (gNB) and the VSG used as a transmitter (Emulated UE).

FIG. 6 shows UCINet0 Architecture for PUCCH Format 0 decoding with 25 neurons in the input layer, 256 neurons in each of the three hidden layers and 12 neurons in the output layer.

FIG. 7 shows the model accuracy for different FCN architectures at various values of Δ.

FIG. 8A shows the Model Accuracy vs. Epoch for simulated data, where training was performed using simulated data at SNR=10 dB.

FIG. 8B shows the Model Loss vs. Epoch for simulated data where training was performed using simulated data at SNR=10 dB.

FIG. 9A shows the Testing Accuracy vs SNR for simulated data, where The test dataset for each SNR contains a combination of N_{UE}={0,1,2, . . . ,12}.

FIG. 9B shows the Testing Accuracy vs SNR for hardware captured data, where the test dataset for each SNR contains a combination of N_{UE}={0,1,2, . . . ,12}.

FIG. 10A shows Testing Accuracy vs Number of Multiplexed UEs (N_{UE}) for simulated data, where the test dataset for each value of N_{UE} contains a combination of SNR={0,5,10,15,20} dB.

FIG. 10B shows Testing Accuracy vs Number of Multiplexed UEs (N_{UE}) for hardware captured data, where the test dataset for each value of N_{UE} contains a combination of SNR={0,5,10,15,20} dB.

FIG. 11A shows Multi-label confusion matrix at SNR=20 dB and A=0 for simulated test dataset, where a represents the UCI specific cyclic shift.

FIG. 11B shows Multi-label confusion matrix at SNR=20 dB and A=0 for hardware captured test dataset, where, a represents the UCI specific cyclic shift.

FIG. 12A shows Multi-label confusion matrix at SNR=20 dB and A=4 for simulated test dataset.

FIG. 12B shows Multi-label confusion matrix at SNR=20 dB and A=4 for hardware captured test dataset.

FIG. 13A shows Confusion matrix for the number of multiplexed UEs N_{UE}, at SNR=0 dB and A=0 for simulated test dataset

FIG. 13B shows Confusion matrix for the number of multiplexed UEs N_{UE}, at SNR=0 dB and A=0 for hardware captured test dataset.

FIG. 14A shows Confusion matrix for the number of multiplexed UEs N_{UE}, at SNR=0 dB and A=4 for simulated test dataset.

FIG. 14B shows Confusion matrix for the number of multiplexed UEs N_{UE}, at SNR=0 dB and A=4 for hardware captured test dataset.

FIG. 15A shows Confusion matrix for the number of multiplexed UEs N_{UE}, at SNR=20 dB and A=0 for simulated test dataset.

FIG. 15B shows Confusion matrix for the number of multiplexed UEs N_{UE}, at SNR=20 dB and A=0 for hardware captured test dataset.

FIG. 16A shows Confusion matrix for the number of multiplexed UEs N_{UE}, at SNR=20 dB and A=4 for simulated test dataset.

FIG. 16B shows Confusion matrix for the number of multiplexed UEs N_{UE}, at SNR=20 dB and A=4 for hardware captured test dataset.

FIG. 17A illustrates Bar graph for the cyclic shift a at SNR=0 dB, A=4, and with N_{UE}={0,1,2, . . . ,12} for simulated test dataset.

FIG. 17B illustrates Bar graph for the cyclic shift a at SNR=0 dB, A=4, and with N_{UE}={0,1,2, . . . ,12} for hardware captured dataset.

FIG. 18A illustrates Bar graph for the cyclic shift a at SNR=20 dB, A=4, and with N_{UE}={0,1,2, . . . ,12} for simulated test dataset.

FIG. 18B illustrates Bar graph for the cyclic shift a at SNR=20 dB, A=4, and with N_{UE}={0,1,2, . . . ,12} for hardware captured dataset.

FIG. 19 shows Line graph showing the number of trainable parameters for different FCN architectures.

FIG. 20 shows the Accuracy vs SNR graphs for different doppler values of both the Neural Network and the conventional algorithm.

### DETAILED DESCRIPTION OF THE EMBODIMENTS

While the invention has been disclosed with reference to certain embodiments, it will be understood by those skilled in the art that various changes may be made and equivalents may be substituted without departing from the scope of the invention. In addition, many modifications may be made to adapt to a particular situation or material to the teachings of the invention without departing from its scope.

Throughout the specification and claims, the following terms take the meanings explicitly associated herein unless the context clearly dictates otherwise. The meaning of “a”, “an”, and “the” include plural references. The meaning of “in” includes “in” and “on.” Referring to the drawings, like numbers indicate like parts throughout the views. Additionally, a reference to the singular includes a reference to the plural unless otherwise stated or inconsistent with the disclosure herein.

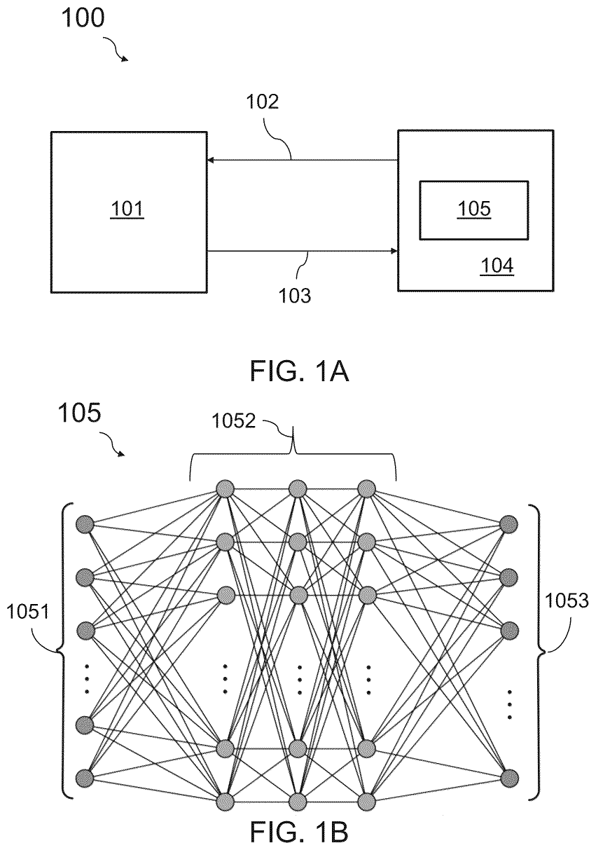

The invention in its various embodiments discloses a system 100 for feedback signaling in wireless communication, with reference to FIGS. 1A and 1B. The system comprises a plurality of User Equipment (UE) 101 configured to receive at least one downlink transmission 102. Each such transmission 102 needs to be acknowledged by the UE signals on PUCCH Format 0. The PUCCH Format 0 signalling is used as initial attach procedure to which at least one UE is configured to latch. The base station 104 is configured to receive the Uplink Control Information (UCI) carried by the PUCCH 103 for decoding. The base station 104 comprises a multi-label neural network classifier 105 configured to decode the signals.

In various embodiments, the multi-label neural network classifier 105 comprises an input layer 1051 containing 12 or more neurons configured to receive 12 or more real or complex sequence inputs, as shown in FIG. 1B. In alternative embodiments, the input layer may contain 24 neurons configured to receive 24 real sequence inputs and an additional optional input for metadata. The classifier then includes one or more dense layers 1052 containing 64 or more neurons as middle layers. The system then includes an output layer 1053 containing 12 or more neurons representing up to 12 or more phase rotation (α) values of the multiplexed users.

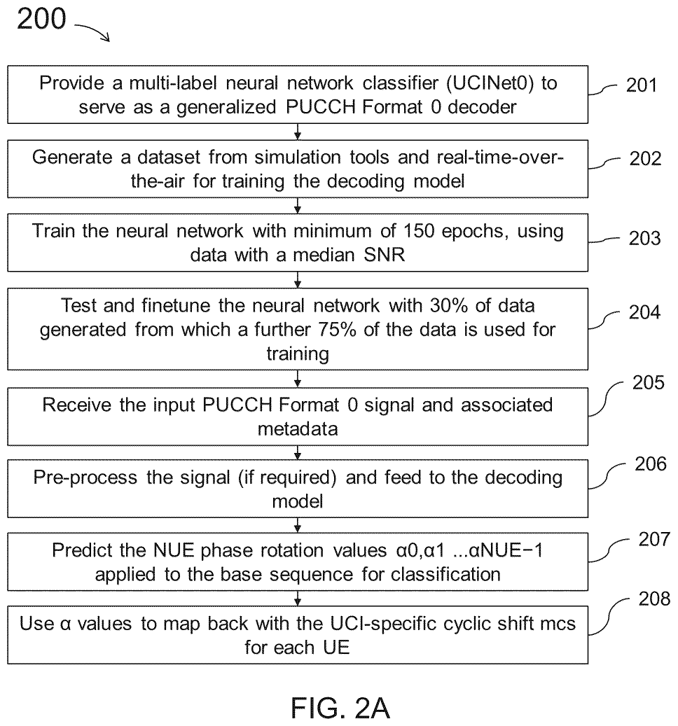

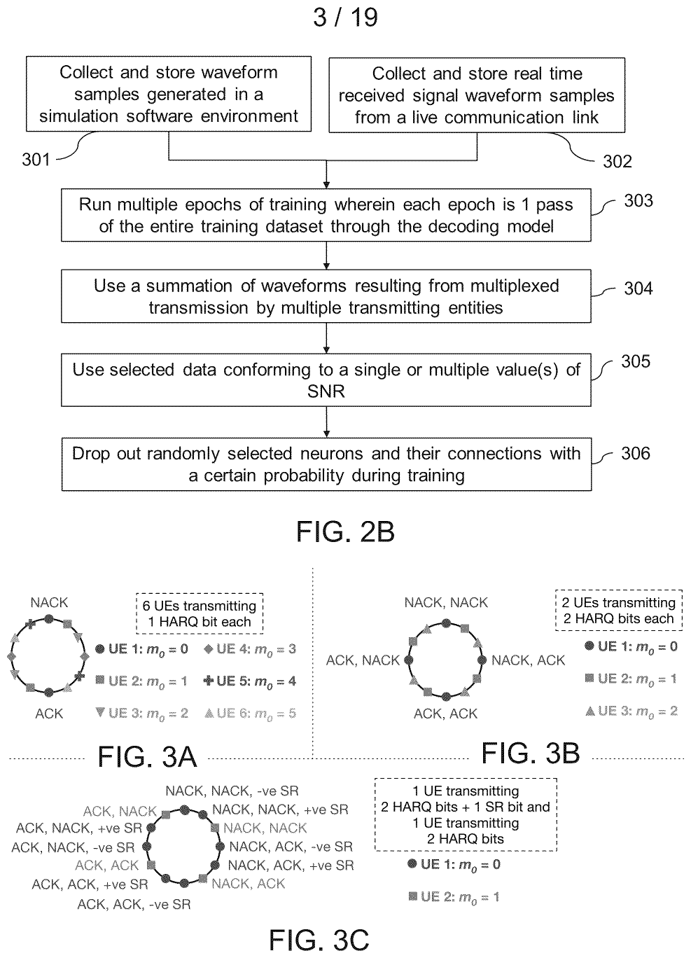

The invention in its various embodiments discloses a method 200 for decoding the UCI wireless communication. As illustrated in FIG. 2A, the method 200 includes the steps of: providing 201 the multi-label neural network classifier 105 to serve as a generalized PUCCH Format 0 decoder. The next step involves generating 202 training datasets for training the neural network. In various embodiments, the training datasets may be generated using simulation tools or real time over-the-air data capture. In some embodiments, the data may be captured using both these methods for training the decoding model. The neural network is then trained 203 by running multiple epochs, using data with one or more SNRs. In one embodiment, the SNR may be a median SNR. . . . In one embodiment of the method, 75% of the data is used for training, from which a further 30% is used for validation and fine-tuning 204 of hyper-parameters. The method then includes receiving 205 the input PUCCH Format 0 signal and associated metadata. In some embodiments, the method may include pre-processing the signal and feeding 206 to the decoding model. The model then predicts 207 the N_{UE} phase rotation values α0,α1 . . . αN_{UE}−1 applied to the base sequence for classification. A final step involves using 208 the α values to map back with the UCI-specific cyclic shift m_{cs} for each UE.

In various embodiments, providing 201 the multi-label neural network classifier (UCINet0) comprises providing the input layer 1051 containing 12 or more neurons configured to receive 12 or more real or complex sequence inputs. In alternative embodiments, the input layer may contain 24 neurons configured to receive 24 real sequence inputs. The method includes using one or more dense layers 1052 containing 64 or more neurons. The output layer 1053 may contain 12 or more neurons representing up to 12 or more phase rotation (α) values of the multiplexed users.

In various embodiments, providing 201 the multi-label neural network classifier (UCINet0) comprises providing the input layer 1051 containing 25 neurons configured to receive 24 real sequence inputs and the metadata as 25^{th} input. The method then includes providing three dense layers 1052 each containing 256 neurons. The method further may include providing an output layer 1053 containing 12 neurons configured to receive up to 12 phase rotation (α) values of the multiplexed users.

In various embodiments, the method 200 involves generating 202 the datasets for training 203 the decoding model. As illustrated in FIG. 2B, generating 202 the dataset for training includes collecting and storing 301 waveform samples generated in a simulation software environment. In alternative embodiments, the method involves collecting and storing 302 real time received signal waveform samples from a live communication link. Further steps for training 203 the decoding model include running 303 multiple epochs of training wherein each epoch is 1 pass of the entire training dataset through the decoding model. The method then uses 304 the summation of waveforms resulting from multiplexed transmission by multiple transmitting entities. The next step involves using 305 selected data conforming to a single value. The training method may also involve dropping 306 out randomly selected neurons and their connections with a certain probability during training.

In various embodiments, training 203 the multi-label neural network classifier 105 comprises running 150 or more epochs of training wherein each epoch is 1 pass of the entire training dataset through the decoding model. In various embodiments, the training 203 may be done on a same hardware on which the method is deployed. In alternative embodiments, the system may be trained on a different equipment and used in the system.

In various embodiments, testing 204 the decoding model includes providing upper bound value of the number of multiplexed users as the metadata input, which is offset from the true value. The prediction 207 comprises determining the N_{UE} phase rotation values α₀, α₁ . . . .αN_{UE}−1 applied to the base sequence for classification. The method includes obtaining 208 either a single α value, multiple α values, or zero α values.

In various embodiments, during early stage of the connection process, neither the UE nor the base station are expected to have obtained detailed information about the wireless surroundings. Generating 202 the dataset for training may include operating the transmitter, or the receiver, or both, in a specific data collection mode to generate specific training sequences. The preprocessing 206 may comprise using a filtering technique such as Fourier Transform, correlation, scaling or absolute value squared to the input signal.

In various embodiments, receiving Uplink Control Information (UCI) carried by the PUCCH 205 at the base station includes Hybrid Automatic Repeat Request (HARQ) acknowledgements for prior downlink transmissions, Scheduling Request (SR) for the subsequent allocation of uplink transmission resources, or Channel State Information (CSI) reports including channel quality metrics that facilitate link adaptation, precoding, and downlink resource allocation.

The invention has multiple advantages as set forth here. The generalized Machine Learning based PUCCH Format 0 receiver system disclosed decodes all the combinations of UCI bits across several multiplexed users. The model is a multi-label classifier that shows superior performance compared to conventional correlation-based approaches by a margin of 5 dB. Thus, the system and method enable prediction accuracy of more than 90 or even 95% over a wide range of variation in neural network configuration used. The inclusion of field datasets in the testing of the model ensures robustness and the ability of the network to work in a wide range of scenarios. The inventive system and method are inherently efficient in minimizing false detection of signals.

### EXAMPLE

### Example 1: 5G NR PUCCH Format 0

The successful establishment of any wireless communication link between two entities relies on feedback signaling from both ends to indicate the channel quality as well as the status of previous transmissions. The Third Generation Partnership Project (3GPP) standards define the 5G NR (New Radio) Physical Uplink Control Channel (PUCCH), which is the key enabler of such feedback in the uplink direction. It is a dedicated channel on which a User Equipment (UE) can send control information to a Base station (gNB). Uplink Control Information (UCI) carried by the PUCCH includes (1) Hybrid Automatic Repeat Request (HARQ) acknowledgements for prior downlink transmissions (Base station to UE), (2) Scheduling Request (SR) for the subsequent allocation of uplink transmission resources, and (3) Channel State Information (CSI) reports containing channel quality metrics that facilitate link adaptation, precoding, and downlink resource allocation. In order to encompass the wide range of capacity and latency requirements of various 5G applications, the 5G standards have provisioned five different formats of the PUCCH transmission, as seen in TABLE 1. Smaller UCI payloads of 1 or 2 HARQ bits and/or an SR are transferred using Formats 0 and 1. Larger payloads, including several SR and HARQ bits, along with CSI reports, are transmitted using Formats 2, 3, and 4. Furthermore, Formats 0 and 2 are suitable for low latency applications since they occupy only 1 or 2 OFDM symbols in the time domain. Formats 1, 3, and 4 are suitable for applications requiring improved coverage and capacity since they extend between 4 and 14 OFDM symbols in the time domain and provide SNR gain.

TABLE 1
Summary of 5G NR PUCCH Formats

| | | | Duration | Resource | | | | |
|---|---|---|---|---|---|---|---|---|
| Format | Payload | Duration | in symbols | Blocks | Waveform | Modulation | DMRS | Multiplexing |
| 0 | HARQ, SR | Short | 1-2 | 1 | CP-OFDM | None (Sequence-based) | No | Yes |
| 1 | HARQ, SR | Long | 4-14 | 1 | CP-OFDM | BPSK or QPSK | Yes | Yes |
| 2 | HARQ, SR, CSI | Short | 1-2 | 1-16 | CP-OFDM | QPSK | Yes | No |
| 3 | HARQ, SR, CSI | Long | 4-14 | 1-16 | DFT-S-OFDM | π/2 - BPSK or QPSK | Yes | No |
| 4 | HARQ, SR, CSI | Long | 4-14 | 1 | DFT-S-OFDM | π/2 - BPSK or QPSK | Yes | Yes |

PUCCH Format 0 is used to transfer one or two HARQ acknowledgments and/or an SR. In 5G, Format 0 signaling is used as early as the initial attach procedure in which a UE is trying to latch onto a gNB. During the initial attach, there are several critical downlink transmissions, such as the Radio Resource Control (RRC) Setup, that need to be acknowledged, which the UE signals on PUCCH Format 0. It is to be noted that at this early stage of the connection process, neither the UE nor the gNB are expected to have obtained detailed information about the wireless surroundings. Consequently, Format 0 employs a sequence-based transmission in which phase-rotated versions of a predefined base sequence are transmitted by the UE. The UCI is encoded in the phase of the base sequence. Since the base sequence is assumed to be known at both ends, Format 0 signaling does not contain any pilot reference signals such as the Demodulation Reference Signals (DMRS), nor does it use Quadrature Amplitude Modulation (QAM) to modulate the UCI bits.

Time-Frequency Allocation, Sequence Generation and UCI Encoding: The cyclically shifted base sequence is mapped to the Resource Grid, where it occupies one Resource Block (RB) in the frequency domain and either one or two symbols in the time domain. One Resource Block in the frequency domain contains 12 Resource Elements (or 12 sub-carriers of the OFDM grid i.e., N_{sc}^{RB}=12). Since PUCCH Format 0 can span two symbols, either 12 or 24 Resource Elements can be occupied. The second symbol contains a sequence similar to that of the first symbol and can be used for SNR enhancement at the receiver. In more concrete terms, the PUCCH Format 0 sequence in the frequency domain includes a phase rotation a applied to a low Peak-to-Average Power Ratio (PAPR) base-sequence r_{u,v}^{α}(k), and is given by

$${r}_{u , v}^{a} ( k ) = {e}^{j α k} \cdot {\overline{r}}_{u , v} ( k ) = {e}^{j α k} \cdot {e}^{j ∅ \frac{( k ) π}{4}} , \qquad ( 1 )$$

where k=0, 1, 2, . . . , N_{sc}^{RB}−1 and ϕ (k) is shown in TABLE 2, which is a set of phase factors that lead to the generation of low PAPR sequences. The subscripts u and v represent the group number and the sequence number within the group, respectively. The values of u and v are configured by higher layer group hopping parameters. We note that when PUCCH Format 0 is two OFDM symbols long, intra slot frequency hopping can be enabled. In this paper, for ease of exposition, we assume that intra-slot frequency hopping is disabled and utilize only one symbol for decoding the UCI bits.

TABLE 2
Definition of φ(n) for M_{ZC} = 12

| | , . . . , | | | | | | | | | | | |
|---|---|---|---|---|---|---|---|---|---|---|---|---|
| 0 | −3 | 1 | −3 | −3 | −3 | 3 | −3 | −1 | 1 | 1 | 1 | −3 |
| 1 | −3 | 3 | 1 | −3 | 1 | 3 | −1 | −1 | 1 | 3 | 3 | 3 |
| 2 | −3 | 3 | 3 | 1 | −3 | 3 | −1 | 1 | 3 | −3 | 3 | −3 |
| 3 | −3 | −3 | −1 | 3 | 3 | 3 | −3 | 3 | −3 | 1 | −1 | −3 |
| 4 | −3 | −1 | −1 | 1 | 3 | 1 | 1 | −1 | 1 | −1 | −3 | 1 |
| 5 | −3 | −3 | 3 | 1 | −3 | −3 | −3 | −1 | 3 | −1 | 1 | 3 |
| 6 | 1 | −1 | 3 | −1 | −1 | −1 | −3 | −1 | 1 | 1 | 1 | −3 |
| 7 | −1 | −3 | 3 | −1 | −3 | −3 | −3 | −1 | 1 | −1 | 1 | −3 |
| 8 | −3 | −1 | 3 | 1 | −3 | −1 | −3 | 3 | 1 | 3 | 3 | 1 |
| 9 | −3 | −1 | −1 | −3 | −3 | −1 | −3 | 3 | 1 | 3 | −1 | −3 |
| 10 | −3 | 3 | −3 | 3 | 3 | −3 | −1 | −1 | 3 | 3 | 1 | −3 |
| 11 | −3 | −1 | −3 | −1 | −1 | −3 | 3 | 3 | −1 | −1 | 1 | −3 |
| 12 | −3 | −1 | 3 | −3 | −3 | −1 | −3 | 1 | −1 | −3 | 3 | 3 |
| 13 | −3 | 1 | −1 | −1 | 3 | 3 | −3 | −1 | −1 | −3 | −1 | −3 |
| 14 | 1 | 3 | −3 | 1 | 3 | 3 | 3 | 1 | −1 | 1 | −1 | 3 |
| 15 | −3 | 1 | 3 | −1 | −1 | −3 | −3 | −1 | −1 | 3 | 1 | −3 |
| 16 | −1 | −1 | −1 | −1 | 1 | −3 | −1 | 3 | 3 | −1 | −3 | 1 |
| 17 | −1 | 1 | 1 | −1 | 1 | 3 | 3 | −1 | −1 | −3 | 1 | −3 |
| 18 | −3 | 1 | 3 | 3 | −1 | −1 | −3 | 3 | 3 | −3 | 3 | −3 |
| 19 | −3 | −3 | 3 | −3 | −1 | 3 | 3 | 3 | −1 | −3 | 1 | −3 |
| 20 | 3 | 1 | 3 | 1 | 3 | −3 | −1 | 1 | 3 | 1 | −1 | −3 |
| 21 | −3 | 3 | 1 | 3 | −3 | 1 | 1 | 1 | 1 | 3 | −3 | 3 |
| 22 | −3 | 3 | 3 | 3 | −1 | −3 | −3 | −1 | −3 | 1 | 3 | −3 |
| 23 | 3 | −1 | −3 | 3 | −3 | −1 | 3 | 3 | 3 | −3 | −1 | −3 |
| 24 | −3 | −1 | 1 | −3 | 1 | 3 | 3 | 3 | −1 | −3 | 3 | 3 |
| 25 | −3 | 3 | 1 | −1 | 3 | 3 | −3 | 1 | −1 | 1 | −1 | 1 |
| 26 | −1 | 1 | 3 | −3 | 1 | −1 | 1 | −1 | −1 | −3 | 1 | −1 |
| 27 | −3 | −3 | 3 | 3 | 3 | −3 | −1 | 1 | −3 | 3 | 1 | −3 |
| 28 | 1 | −1 | 3 | 1 | 1 | −1 | −1 | −1 | 1 | 3 | −3 | 1 |
| 29 | −3 | 3 | −3 | 3 | −3 | −3 | 3 | −1 | −1 | 1 | 3 | −3 |

The cyclic shift a applied to the base sequence is given by,

$$α = \frac{2 π}{{N}_{sc}^{RB}} ( ( {m}_{0} + {m}_{cs} + {n}_{cs} ( {n}_{s , f}^{μ} , l + {l}^{′} ) ) mod {N}_{S C}^{RB} \qquad ( 2 )$$

where,
m₀ ∈ [0,11] is the initial cyclic shift that is used to differentiate various multiplexed users.
m_{cs} is the UCI-specific cyclic shift shown in TABLE. 3.
n_{cs} (n_{s,f}^{μ}, l+l′) is a function based on the pseudo random binary sequence
   n_{s,f}^{μ} is the slot number in the radio frame
   l is the OFDM symbol number in the PUCCH transmission where 1=0 corresponds to the first OFDM symbol of the PUCCH transmission.
   l′ is the index of the OFDM symbol in the slot that corresponds to the first OFDM symbol of the PUCCH transmission in the slot

TABLE 3
Possible m_{cs} values in PUCCH Format 0

| UCI Content | Possible m_{cs} values |
|---|---|
| 1 HARQ | 0 (ACK), 6 (NACK) |
| 2 HARQ | 0 (NACK, NACK) |
| | 3 (NACK, ACK) |
| | 6 (ACK, ACK), |
| | 9 (ACK, NACK) |
| 1 SR | 0 (+ve SR) |
| 1 HARQ + | 0 (NACK, −ve SR), |
| 1 SR | 3 (NACK, +ve SR) |
| | 6 (ACK, −ve SR), |
| | 9 (ACK, +ve SR) |
| 2 HARQ + | 0 (NACK, NACK, −ve SR), |
| 1 SR | 1 (NACK, NACK, +ve SR) |
| | 3 (NACK, ACK, −ve SR), |
| | 4 (NACK, ACK, +ve SR) |
| | 6 (ACK, ACK, −ve SR), |
| | 7 (ACK, ACK, +ve SR) |
| | 9 (ACK, NACK, −ve SR), |
| | 10 (ACK, NACK, +ve SR) |

PUCCH Format 0 Transmission Scenarios: While m₀ and n_{cs} are drawn from higher layer (L2) configurations, the UE chooses the m_{cs} depending on the UCI content it transfers. Consider the following two examples of possible PUCCH Format 0 transmission scenarios.

Single UE transmission: A single UE scheduled to transmit on a particular time frequency allocation chooses an m_{cs} value based on its UCI content as defined in FIG. 2B. In the FIG. 2B, NACK and ACK refer to Negative and Positive Acknowledgments, respectively. +ve SR indicates an SR transmission and a-ve SR denotes that an SR is not transmitted despite the PUCCH resource allocation (the UE does not require uplink PUSCH allocations).

Multiplexed UE Transmission: In the interest of optimizing radio resources, PUCCH Format 0 has a unique potential to multiplex more than one UE on the same time-frequency locations. This is achieved by allocating different initial cyclic shifts (m₀) to each UE. Since the number of possible values of m₀ is limited to 12, the number of UEs that can be multiplexed is upper-bounded by 12. The maximum number of UEs that can be multiplexed is also driven by the UCI content. A few examples of this are shown in FIG. 3. FIG. 3A shows how assigning m₀ values of 0 through 5 to a maximum of 6 different UEs allows each of them to pick one of the two possible cyclic shifts and transmit 1 HARQ bit on the same resources. Similarly, FIG. 3B shows that m₀ values of 0 through 2 allow for 3 UEs to be multiplexed when each of them transmits 2 HARQ bits (or 1 HARQ and 1 SR bit) with one of the four possible cyclic shifts. Additionally, multiplexing across different types of UCI content is possible, wherever applicable. For example, a UE transmitting 2 HARQ bits and an SR bit cannot be multiplexed with another transmitting the same combination but can be multiplexed with up to 3 more UEs transmitting SR bits or 1 more UE transmitting 2 HARQ bits as shown in FIG. 3C. Multiplexing of multiple UEs is possible as long as there are no overlaps in the assigned possible cyclic shifts for each of the UEs.

Accounting for UE multiplexing, the generalized multi-user Format 0 received signal in the frequency domain is given by,

$$y ( k ) = {Σ}_{m = 0}^{{N}_{UE} - 1} {h}_{m} ( k ) {e}^{j {α}_{m} k} \cdot {r}_{u , v} ( k ) + w ( k ) \qquad ( 3 )$$

where k=0, 1, 2, . . . , N_{sc}^{RB}−1, N_{UE} is the number of multiplexed UEs in a given resource block, hm (k) is the channel between the mth UE and the gNB in the kth Resource Element, am is the phase rotation applied to the base sequence by the mth UE (Observe that all multiplexed UEs use the same base sequence). The noise is denoted by w (k).

Existing Receiver Methods for PUCCH Format 0: We reiterate that Format 0 has no provision for DMRS (pilots), and hence, there is no channel estimation or equalization possible. Blind correlation methods exist for such scenarios in which channel information is unknown, but these methods are often reserved for scenarios in which the resource allocation information is also not known. One example of such a scenario is the initial time synchronization between the gNB and the UE. Since the allocation of the synchronization sequences is unknown, longer correlations need to be performed. But, by the time the first Format 0 signal is received at the gNB, time and frequency synchronization are already achieved, and the gNB is aware of the UE's transmission. Since the allocation is known and is always 1 RB long, a simpler length 12 correlation is sufficient.

Various receiver techniques correlation relies on the fact that the low PAPR base sequence used for encoding the UCI content is known at the receiver. The decoding method involves correlating the received samples with various cyclically shifted versions of the base sequence. The predicted cyclic shift is the cyclic shift that gives the highest correlation magnitude. It should be noted that peak selection, by definition, requires an optimal threshold for determining whether a peak is due to noise or a true transmission. Correlation-based signal detection outperforms methods based on raw signal power measurements even under fading channel scenarios. A normalized correlation-based solution for identifying false detections of HARQ bits uses the probability distributions of a normalized correlation peak to determine the optimum threshold for classifying a reception as false. The existing PUCCH format 0 receiver algorithm eliminates phase opposition across multiple hops by finding the sum of correlation magnitudes across symbols instead of correlation values.

In the 5G testbed deployment at IIT Madras, the correlation is implemented by an equivalent DFT-based algorithm. Later this is used as a baseline for comparison. Such an algorithm proves to be better from a hardware perspective due to its optimized use of resources (avoiding the need to correlate with all the shifted base sequences), reduced latency, and higher throughput. In the IIT Madras 5G testbed, a DFT-based receiver for PUCCH Format 0 has been implemented on custom Field Programmable Gate Array (FPGA) boards for real-time operations. This method recovers the phase rotation a by taking the 12-point DFT of (n)·r_{u,v}(n). Since y(n)=e^{jan}. r_{u,v}(n), the multiplication of the base sequence r_{u,v} with its complex conjugate forces it to unity. The 12-point DFT of the resultant exponential term e^{jan} results in a peak at a.

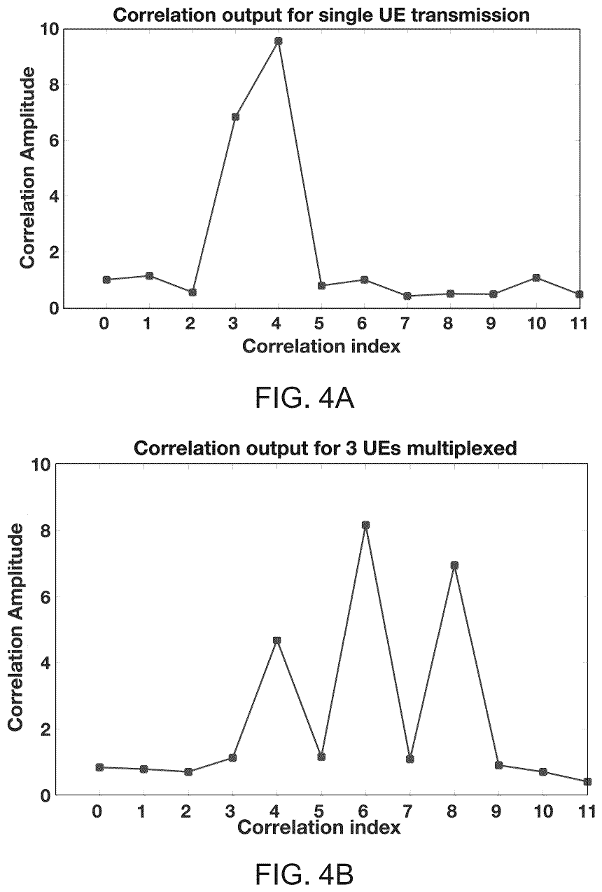

As illustrated in FIG. 4A with a correlation peak at index=4. The correlation index corresponding to the maximum correlation amplitude is taken as the estimated α value. Recall from (2) that α is a combination of m₀, m_{cs} and n_{cs}. Therefore, upon the subtraction of m₀+n_{cs} from a (subtraction is modulo 12), the UCI-specific cyclic shift m_{cs} remains. In scenarios where multiple users (N_{UE} of them) transmit PUCCH Format 0 signals in the same time-frequency location, the DFT algorithm selects the top N_{UE} peaks from the DFT output and uses them to determine the m_{cs} for each of the N_{UE} multiplexed UEs. FIG. 4B shows an example in which 3 UEs are multiplexed. In this case, we select the top 3 peaks (at index=4,6, and 8) as α values. We observe that while the above works in literature do provide false and missed detection performance analysis, they are based on fixed thresholds that are specific to a certain scenario and derived from lengthy Monte Carlo simulations.

Furthermore, fixed thresholds do not account for the received signal power variations that are caused due to variations in gains of hard ware elements such as the LNA and due to varying locations of the multiplexed UEs. For example, a true transmission with large distance-based path loss could be misclassified as false if a fixed threshold is used.

Finding a one-size-fits-all threshold for various channel environments and multiplexed UEs is non-trivial. This has led us to explore an AI/ML-based data-driven approach in which a receiver could be designed directly from the raw frequency domain signals rather than correlation values. We apply similar techniques here. The IQ samples in the received resource block are analogous to pixel values in an image. Hence, models that work for image classification could potentially work here too.

### Example 2: Machine Learning Receiver for PUCCH Format 0 Detection

To our knowledge, there is limited work on applying AI/ML toward the decoding of Format 0 signals in literature. The architecture described to support all the possible UCI payloads shown in FIG. 2A and all the possible multiplexing combinations of UEs (N_{UE}=0,1, . . . ,12). This generalized architecture is designed for potential field deployment in any 5G gNB. This section lays down the framework for posing the PUCCH Format 0 detection as an AI/ML classification problem. Specifically, we show how a single multi-label neural network classifier can serve as a generalized PUCCH Format 0 decoder.

PUCCH Format 0 as an AI/ML classification problem: Classification, a widespread use case of machine learning algorithms, is a supervised learning task that involves identifying to which class (label) a given data instance belongs. A predictive model, typically a Neural Network, is trained with a dataset that contains several input instances and the corresponding ground truth class labels. Labeled data helps us supervise the NN in learning the correct input-output mapping. Learning happens by iteratively minimizing a loss function, which is a distance metric between the predicted label and the ground truth label. In many classification tasks, the input-output mappings are intractable. ML techniques, such as Neural Networks, have proven to be more adept at extracting these mappings.

There are typically three types of classification tasks. The first is Binary Classification, in which the input data falls into one of two classes. An example of this is email classification as spam or not spam. The second is multi-class classification, in which input data could belong to one of more than two classes. A routinely cited example is classifying handwritten digit images into one of ten numbers. The third is multi label classification, in which input data can independently belong to more than one class. An example of this is the identification of multiple genres a movie belongs to, given a summary of its plot.

For PUCCH Format 0, the classification task is as follows: Given a sequence of received frequency domain Format 0 samples, predict the N_{UE} phase rotation values α₀, α₁ . . . αN_{UE}−1 (3) applied to the base sequence. The obtained α values can then be mapped back to the UCI-specific cyclic shift m_{cs} for each UE by modulo 12 subtractions of the corresponding m₀ and n_{cs} which are provided by the higher layers (L2). In the case where no user is transmitting on the PUCCH (N_{UE}=0), the NN prediction has to reflect this. In summary, the NN classifier has to predict either a single α value, multiple α values, or zero α values. Such a pattern of prediction is a typical use case of multi-label classification.

Data Generation and Representation: Dataset generation in AI/ML for wireless communication has a unique challenge not present in other domains—the non-availability of off-the-shelf benchmark datasets. One way of developing such datasets is through state-of-the art simulation tools, such as the MATLAB 5G Toolbox, which can generate near-accurate datasets under various channel impairments. Simulated data is a good starting point for training neural networks in communication problems. However, we note that including field data, if available, gives us an insight into the generalization performance of AI/ML models across different distributions of data. For this invention, we use a combination of the above two approaches for data generation.

Simulated datasets: Using the MATLAB 5G Toolbox, we generate the received waveforms containing the PUCCH Format 0 signals. These generated waveforms include fading channel impairments and Additive White Gaussian Noise (AWGN). For various SNR values (0, 5, 10, 15, and 20 dB), we generate PUCCH signals transmitted over a TDL-C Channel and store the noisy received samples. These samples are the input to the NN. For each input, the corresponding output label is the applied phase rotation a for each of the N_{UE} UEs in multi hot encoded format. The pseudocode for generating PUCCH Format 0 datasets in MATLAB is shown in Algorithm 1. We first place PUCCH Format 0 signals on all 14 symbols in a slot and 12 resource blocks in each symbol spaced 20 resource blocks apart. This results in 168 allocations per resource grid. We generate 1000 iterations of such resource grids. These 1000 grids are generated for each value of N_{UE} in the range 0 to 12. The process is further repeated for the five SNR values.

```
Algorithm1:
NUE ={0,1,2,...,12}
SNR ={0,5,10,15,20} dB
fd = {0,500,1000,1500,2000} Hz
Iter = {1,2,...,1000}
foreach NUE, SNR, fd, Iter do
  n_{UE} =0,1,2,...,N_{UE}
  foreach u ∈ n_{UE} do
    foreach c ∈ {1,2,...,168} do
      bit_len_harq ∈ {0,1,2}
      bit_len_sr ∈ {0,1}
      Generate UCI bits and label (α)
      Generate Format 0 signal and place it in the resource grid
  OFDM Modulation of the TX OFDM grid
  Transmit over channel
Receive combined signal from N_{UE} UEs (3)
Perform OFDM Demodulation to obtain the RX grid
foreach c ∈ {1,2,...,168} do
  Extract and save Format 0 signal
```

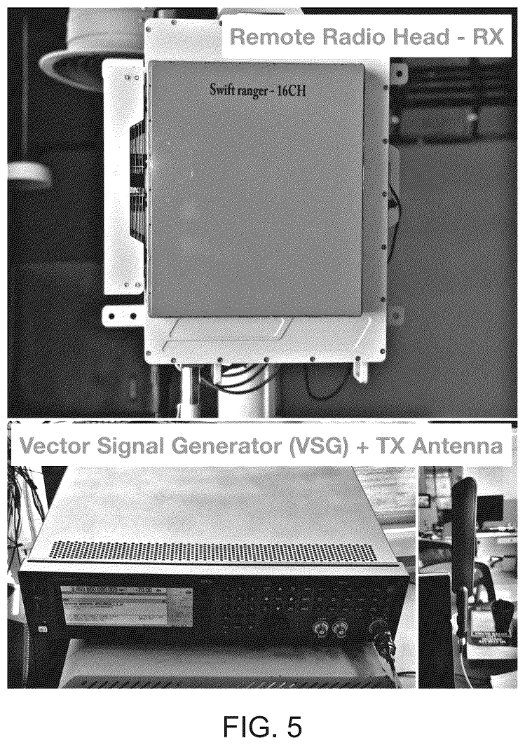

Real-time over-the-air datasets: We use hardware captures derived from the state-of-the-art 5G testbed at IIT Madras for more realistic testing. The hardware captures help represent channel states and hardware impairments not included in the training dataset. The setup as shown in FIG. 5 consists of an N5182B Vector Signal Generator (VSG) for transmitting the 5G signal at a center frequency of 3.49986 GHz (one of the sub-6 GHz channel raster in the n78 band). In our setup, the VSG acts like a UE, and it uses a commercial omnidirectional wideband monopole antenna to transmit the signals. The VSG is connected to the antenna through 2 SMA cables with 1.9 dB wire loss each. Here, commercial UEs could not be used because it is not easy to extract the actual transmitted information, i.e., ground truth labels for the UCI transmissions made by the UE. Also, the dynamic nature of the allocations made by the L2 scheduler makes it difficult to capture the data at the gNB for that particular time duration.

A multi-channel 5G Remote Radio Head (RRH) with a dual-polarized antenna at the gNB receives the signals from over the air (for the purpose of the paper, we utilize only one antenna and one transceiver chain). The RRH operates in the n78 band with 100 MHz bandwidth. It is ORAN-compliant and follows the 7.2 b split other receiver components of the RRH include an in-house Low Noise Amplifier (LNA) with 60 dB gain at the receiver front end and an ADRV 9009 RF transceiver. We place the transmitter antenna one meter away from the receiver. The PUCCH Format 0 signal is transmitted from the VSG through an antenna, over the air, and then received at the RRH antenna, followed by the LNA and the transceiver. The signal out of the ADC is then collected and used for testing.

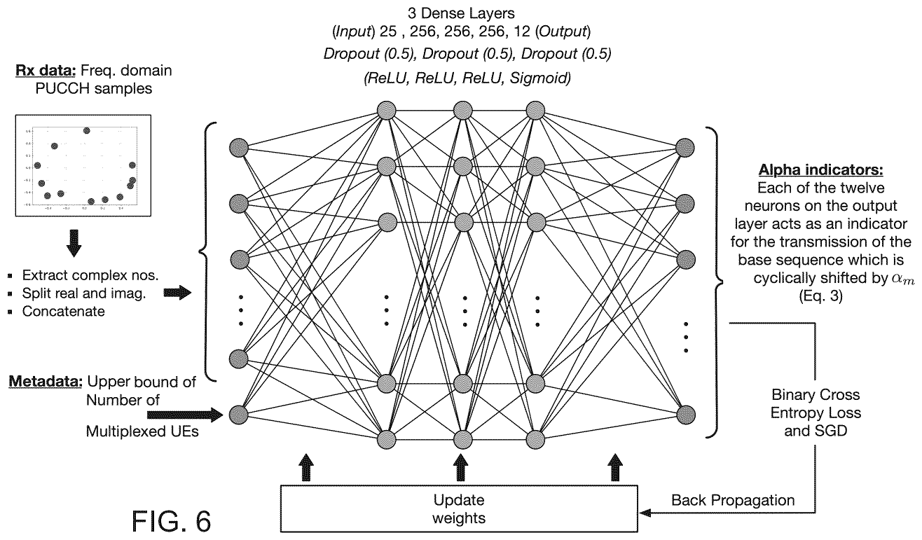

NEURAL NETWORK ARCHITECTURE: Given a problem statement, there is no formula for knowing a priori, the best neural network architecture. For most problems, initial architectures are determined based on prior experience and domain knowledge. These architectures are then tuned by experiment. FIG. 6 shows the UCINet0 architecture that showed the best performance in the experiments. In subsequent sections, we also comment on the trade-off between high complexity and performance.

Neural Network structure: The input to the NN has two components. The first is the received PUCCH Format 0 signal, and the second is metadata indicating the number of multiplexed UEs that the receiver expects. Since the PUCCH Format 0 signals occupy a single Resource Block, there are 12 received complex samples. We separate the real and imaginary parts of each complex number and concatenate them, resulting in a length 24 real sequence. As shown in Eq. (3), a given PUCCH resource block at the receiver could contain the sum of signals from multiple UEs. To aid the neural network, we also feed the number of multiplexed UEs as a 25^{th} metadata input. The number of multiplexed UEs that α receiver should expect to see is often provided by an L2 scheduler as an upper bound, meaning that the received signal could contain less than or equal to the number of UEs indicated by L2. We denote the difference between the actual number of UEs multiplexed and the number of UEs indicated by L2 as A. One example of a scenario where this is observed is when the L2 scheduler allocates multiple UEs to transmit SR, but not all of the UEs have any data to transmit. In such cases, UEs that do not require PUSCH resources do not transmit the SR.

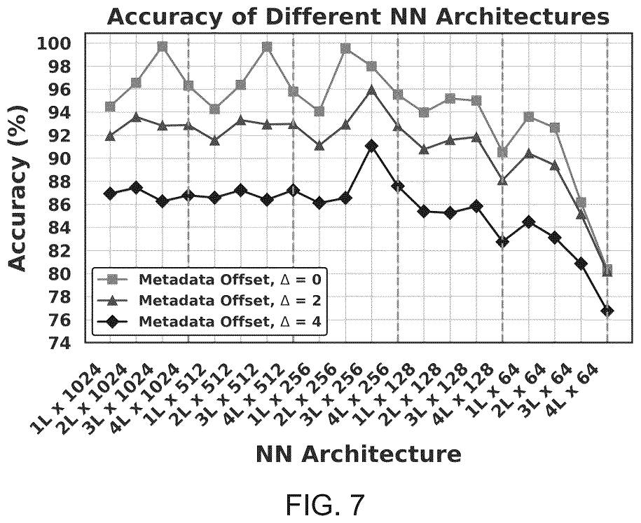

Owing to the relatively small dimension of the input, our proposed UCINet0 is a Fully Connected Neural Network (FCN). As shown in FIG. 4, there are 3 dense layers, each containing 256 neurons. The output layer contains twelve neurons corresponding to the twelve α values. We arrived at the final UCINet0 architecture of 3 layers and 256 neurons after having evaluated the performance of other architectures with a varying number of layers and neurons. FIG. 7 shows the UCI decoding accuracies obtained with 20 variations of FCN architectures. Here, A represents the maximum metadata offset between the true value and L2's upper bound for the number of multiplexed UEs. We considered combinations of 1, 2, 3 and 4 layer models with 64, 128, 256, 512 and 1024 neurons. From FIG. 7, we observe the following:
Model performance generally improves as we increase the number of neurons from 64 to 1024 for any number of layers and for values all of Δ.
For Δ=0, both 1024 and 512 neurons result in almost the same accuracy values for a given number of layers. For example, 2 layers×1024 and 2 layers×512 result in similar accuracy values.
For higher values of Δ, the accuracy drops as the number of layers increases beyond a certain value as the model begins to overfit.
For Δ=4 and 1024 neurons, the accuracy drops beyond 2 layers, whereas for 512 neurons, the accuracy drops beyond 3 layers.
   Hence, considering the balance between the number of layers, number of neurons, and accuracies for various Δ values, 3 layers with 256 neurons architecture seems to be the optimal choice.

Dropout: Dropout is used during training to drop out or cut off certain neurons and their connections randomly with a certain probability during training. It serves two purposes: Ensemble Learning and Regularization. Ensemble learning helps improve predictive performance by combining the outputs of multiple AI/ML models or multiple instances of the same AI/ML model trained on different subsets of data. However, training a large number of models is extremely prohibitive both in terms of time and computational resources. With dropout, in each backward pass, only a subset of weights is updated, effectively resulting in a new neural network. The subset of weights that are updated varies with each forward and backward pass, thus creating the combined effect of training several neural networks without the significant computational overhead. Dropout also has a regularizing effect on training in that it makes training noisy and, as a result, doesn't allow neurons to co-adapt. This means that neurons in one layer will learn not to depend on or compensate for other neurons because these very neurons may randomly be dropped out. This encourages neurons to become more independent, thus preventing overfitting. All the models described in this paper use dropout with a probability of 0.5 in each of the hidden layers.

Activations and backpropagation: The hidden layers use a ReLU activation function, and the output layer uses a Sigmoid activation function. The use of the sigmoid activation function is motivated by the fact that in a multi-label classifier, the sum of all the output probabilities need not be 1. Each individual output neuron can be thought to be a part of an independent binary classifier. In other words, since each output neuron corresponds to an α value, the probabilities of each output neuron indicate the confidence with which the NN detects the presence of a certain UE with a certain a value. The output probabilities are used to compute a binary cross entropy loss that is back propagated using Stochastic Gradient Descent (SGD) with a learning rate of 10-2 and a momentum parameter of 0.9.

Training and Testing: We consider received signal data corresponding to 5 SNR values i.e., 0,5,10,15.20 dB. The training instances are designed such that they encompass all the possible cases of multiplexed UEs including the cases where no UEs are transmitting. During training, we assume that the metadata input always holds the correct number of UEs present in the signal. Furthermore, based on the insights gained from our previous work, we train the neural network only using data with a middle SNR of 10 dB, rather than all the SNRs. We have found that this model achieves good generalization across the entire range of SNR during inference/testing. 75% of the data is used for training from which a further 30% is used for validation and fine-tuning of hyper-parameters. Glorot uniform initialization of weights was used to initialize the network. We trained the model for 150 epochs (an epoch is 1 pass of the entire dataset through the neural network). The training and testing were done using Python and TensorFlow. In the inference phase, we test the model using data from all SNRs. We also incorporate the fact that the number of multiplexed UEs in a real-time deployment may not be exactly known. The L2 scheduler in a gNB merely provides α value for the upper bound of the number of UEs a receiver could possibly expect in a given PUCCH allocation. This is usually a consequence of one of the following scenarios:
A UE does not transmit any SR if no uplink grants are required because of lack of data into buffer
A UE does not transmit feedback (on HARQ resources) if the prior downlink message is not detected.

During testing, we feed this upper bound value as the metadata input to the neural network, which is offset from the true value. To test the robustness of the trained model, we consider various cases of the maximum metadata offset Δ between the true value and L2's upper bound for the number of multiplexed UEs. For example, Δ=0 indicates that the number of UEs provided as the metadata input to the NN matches the number of UEs actually transmitting in the given allocation. Δ=2 indicates that for each test instance, the number of UEs provided as the metadata input to the NN could be offset by any value between 0 and 2 with 0 being the best case (no offset) and 2 being the worst. We show results for Δ=0,2,4.

Eq. (4) shows the offset added to the true value of the number of multiplexed UEs, N_{UE} to obtain Ñ_{UE} which is the expected number of multiplexed UE at the receiver, as indicated by L2. Note that since the maximum number of UEs that can be multiplexed in a given resource block is 12, the value of Ñ_{UE} is chosen accordingly as:

$${\tilde{N}}_{UE} ∈ [ {N}_{UE} , {N}_{UE} + Δ ] \qquad ( 4 )$$

### Example 3: Performance Metrics of the New Model

We use model test accuracy as the main performance metric. We also show confusion matrices to indicate the distribution of model predictions. Wherever appropriate, we show com parisons of the model performance with the corresponding performance shown by the DFT algorithm. Accuracy is simply the number of correct predictions in relation to total predictions. Though it is a useful high-level metric to gauge model performance, in cases where the classes in a dataset are unequally distributed or when, as is the case in this paper, there are more than 2 classes, accuracy alone as a metric for an NN classifier does not offer the full picture of model performance. It is helpful to know if the model classifies all classes equally well or if it is more “confused” by certain classes compared to others. Hence, calculating a confusion matrix gives a better insight into any patterns that may exist in both correct and wrong classifications made by the model. In this paper, we show 3 types of confusion matrices: (1) A multi-label confusion matrix that shows how well each a is predicted; (2) A confusion matrix showing how well the model predicts the correct number of multiplexed UEs, and (3) A confusion matrix showing how each value of a (including the cases when no a is selected) is classified. We present this last metric in the form of a column chart for ease of visualization. These 3 types of confusion matrices provide a sense of interpretability of the inner workings of the NN model.

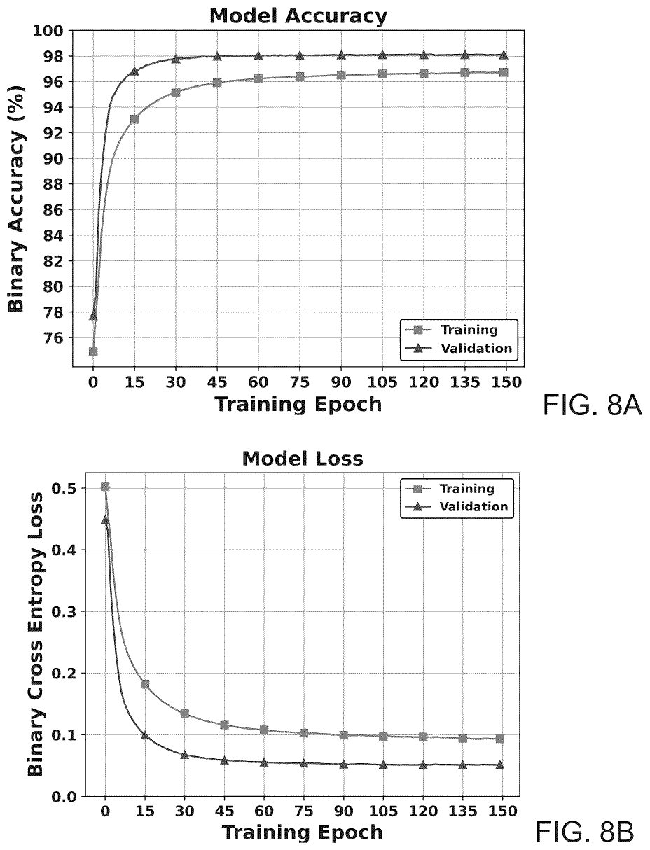

Accuracy and Loss: FIG. 8A shows the training and validation accuracy with respect to the training epochs. FIG. 8B shows the training and validation loss. Both curves follow the expected pattern for a well-fit model. The accuracy/loss gradually increases/decreases with epoch and eventually converges. We also note that the validation accuracy and loss values are slightly better than the corresponding training values. One possible explanation for this could be the use of dropout. As stated above, a dropout with probability 0.5 drops neurons 50% of the time during training. However, during validation and testing, the entire model is used, leading to a higher accuracy/lower loss.

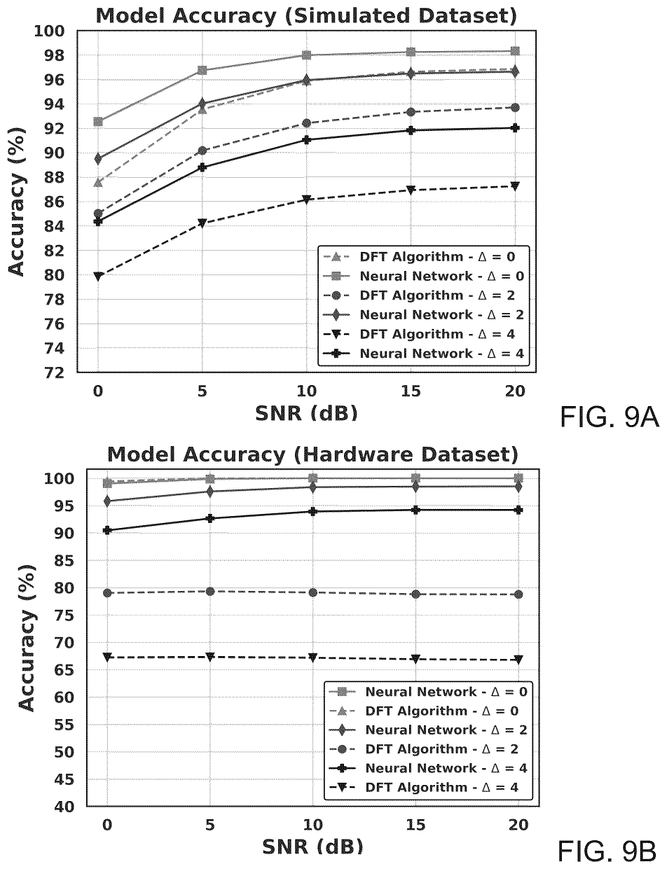

FIG. 9A shows the test accuracy of the model versus SNR for simulated data. FIG. 9B shows the test accuracy of the model versus SNR for hardware-captured data. In both cases, the test dataset for each SNR contains a combination of all possible values of N_{UE}={0,1,2, . . . , 12}. Both FIGS. 9A and 9B show that model accuracy increases with SNR. For the simulated data, the model significantly outperforms the DFT algorithm for all values of Δ. For the hardware captured data, when Δ=0, the model performs slightly better than the DFT algorithm. But as the SNR increases, the accuracies of the model and that of the DFT algorithm converge. This is because Δ=0 constitutes a best-case scenario in which both algorithms are aided by the fact that the receiver knows exactly how many UEs are multiplexed. At higher values of Δ, the convergence is not seen, and the NN model shows a significant gain compared to the DFT algorithm.

Furthermore, from FIGS. 9A and 9B, we observe an interesting difference between the performance of the neural network with simulated data versus hardware captured data. For all values of Δ, there is a significant SNR gain with the hardware data compared to simulated data. For example, when Δ=0, the accuracy with hardware captured data reaches 100% at as low an SNR as 5 dB. In contrast, the accuracy with simulated data requires more than 15 dB SNR to reach 100%. This difference could be attributed to the characteristics of the datasets themselves. The simulated dataset includes a strong fading component that impairs the transmitted signal. However, owing to the short propagation distance, such a strong fading component is absent in the current 5G testbed setup that was used to obtain the hard ware captures. We note that the captures still incorporate other real-world impairments caused by front-end hardware elements like filters, DACs, ADCs, up/down converters, and amplifiers. In summary, the hardware dataset models impairments due to front-end elements well. It also models over-the-air impairments but does not encapsulate all characteristics of a typical communication link between a gNB and UE that might span hundreds of meters. On the other hand, the simulated data models over-the-air characteristics well but it doesn't model impairments due to hardware elements. We also point out that the IIT Madras 5G Testbed is moving towards deployment of Remote Radio Heads at on-campus sites which will allow the inclusion of even more realistic field data into future work.

Another observation from FIGS. 9A and 9B is that the DFT algorithm performs worse on hardware data, showing that it is negatively affected not only by impairments from hardware elements but also by even the slightest over-the air fading. On the other hand, the NN Model outperforms the DFT method in all scenarios of hardware and simulated datasets.

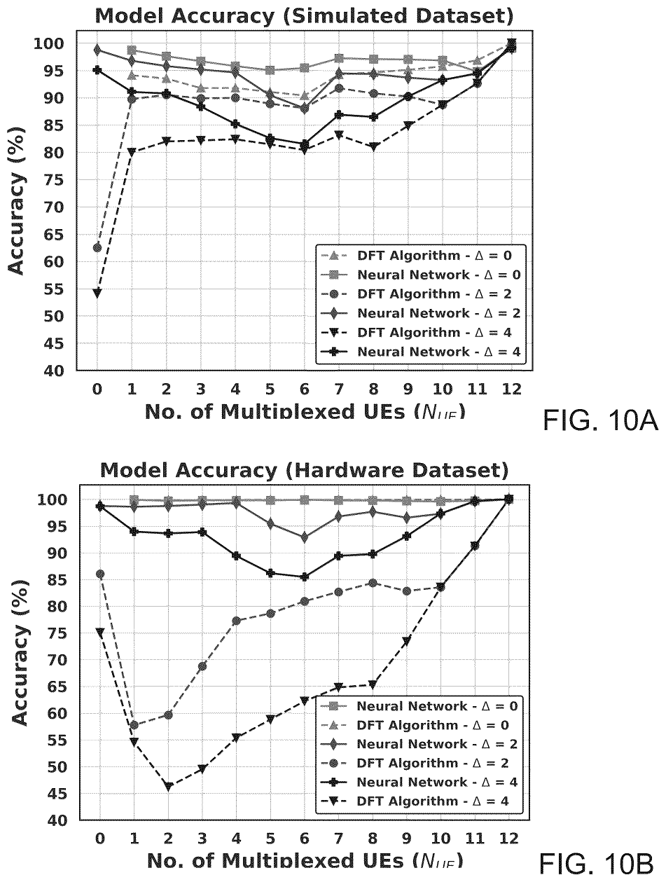

FIG. 10A shows the test accuracy of the NN model versus the number of multiplexed UEs (N_{UE}) for simulated data. FIG. 10B shows the test accuracy of the NN model versus the number of multiplexed UEs (N_{UE}) for hardware-captured data. In both cases, the test dataset for each N_{UE} contains a combination of all possible values of SNR={0,5,10,15,20} dB. It is clear that the accuracy decreases as the maximum offset Δ increases. Note that no value is plotted when N_{UE}=0 and Δ=0 since this case corresponds to the scenario in which no UEs are transmitting on a given Resource Block and the receiver knows apriori that no UEs are scheduled as well. In this case, the receiver need not even run. When N_{UE}=12, all the multiplexed UEs transmit only Scheduling Requests (SR). For both the simulated and hardware datasets, the DFT algorithm selects all 12 values from the 12-point DFT and assigns one value to each UE. Since all UEs are transmitting SRs, the order of assignment doesn't matter, and hence the accuracy is always 100%.

The NN model also seems to recognize that the only scenario in which 12 UEs can be multiplexed is when they all transmit exactly the same information, i.e., SRs. Lower values of N_{UE} tend to result in lower accuracy values. This is because the DFT algorithm picks up the top N_{UE} values of the 12-point DFT, and the probability of a true value lying in one of the 12-N_{UE} locations increases as N_{UE} decreases. We observe a similar pattern in the case of decoding with the proposed UCINet0 as well.

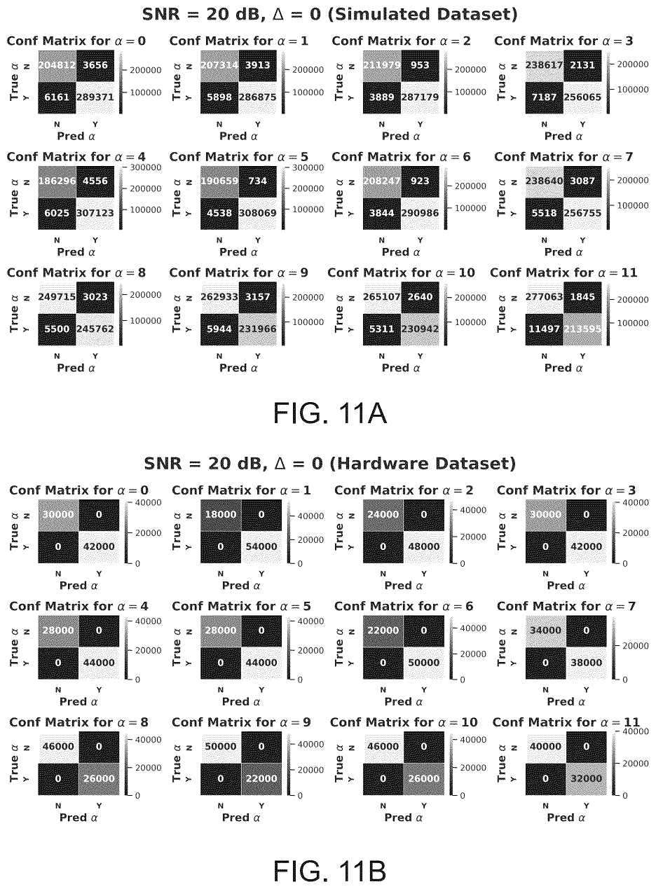

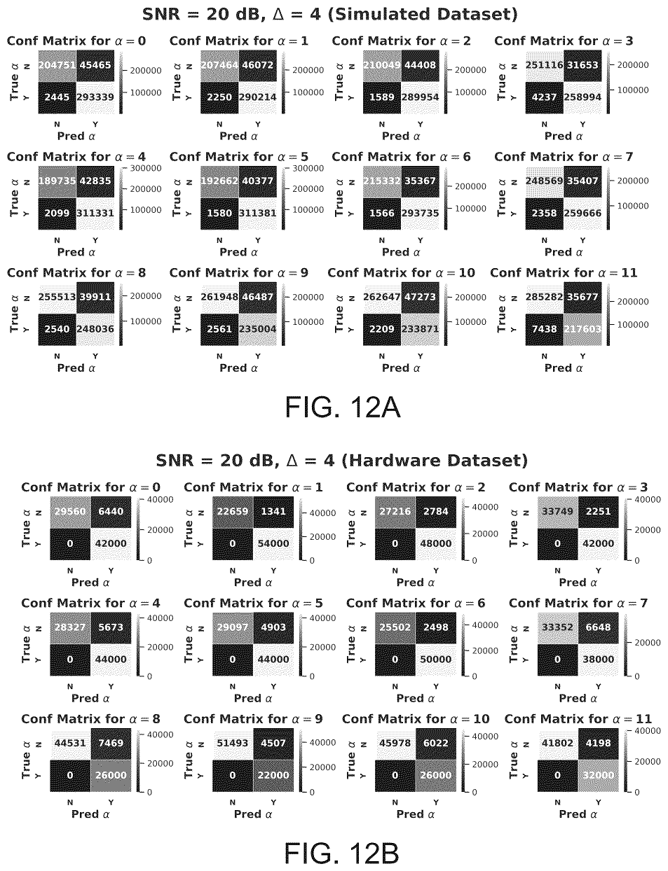

Confusion Matrices and Column Charts: The confusion matrices in FIG. 11A-11B and FIG. 12A-12B indicate the overall multi-label classification performance of the model via multi-label confusion matrices for the best (Δ=0) and worst (Δ=4) cases of 20 dB SNR respectively, for both simulated data and hardware-captured data. Multi-label classification can be thought of as a combi nation of several independent binary classifiers. Diagonally dominant confusion matrices indicate that each of the binary classifiers is well-trained. For a given SNR, as A increases, the model leans more towards false positives because the model (whose 25^{th} input is ÑUE E [N_{UE}, N_{UE}+A]) is trying to predict N_{UE} number of UEs. The value of A is always positive, meaning that the number of expected UEs, as indicated by L2, is always greater than or equal to the actual number of UEs transmitting on a given resource allocation. Hence, the model almost always over-predicts.

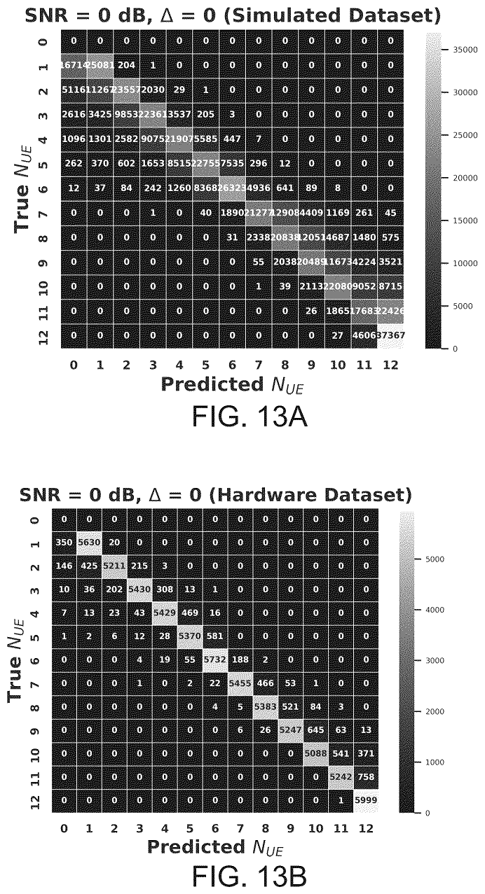

However, it should be noted that the multi-label confusion matrix does not show the exact details of misclassifications. To gain a deeper understanding of the mistakes made by the model, consider the matrices in FIGS. 13 to 16. For each instance of the received PUCCH signal, there are two characteristics to correct classification. The first characteristic is the correct identification of the number of multiplexed UEs (N_{UE}) embedded in the signal. Even though this is not an explicit output of the NN model, we believe that the model is learning to perform some kind of estimation of the number of multiplexed UEs. Our belief is based on the fact that when the number of possible multiplexed UEs is not given as metadata to NN input, the accuracy drops significantly. The second characteristic of correct classification is derived from the explicit output of the NN model, which is the correct prediction of the value of a for each of the multiplexed UEs.

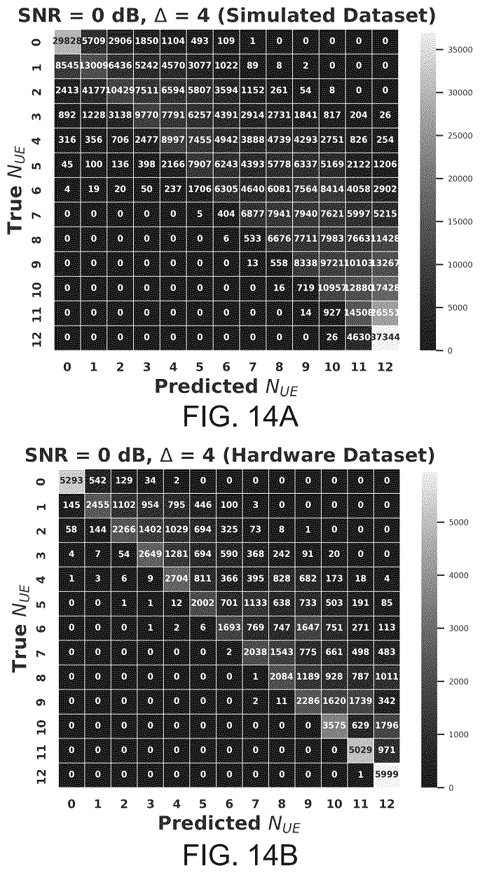

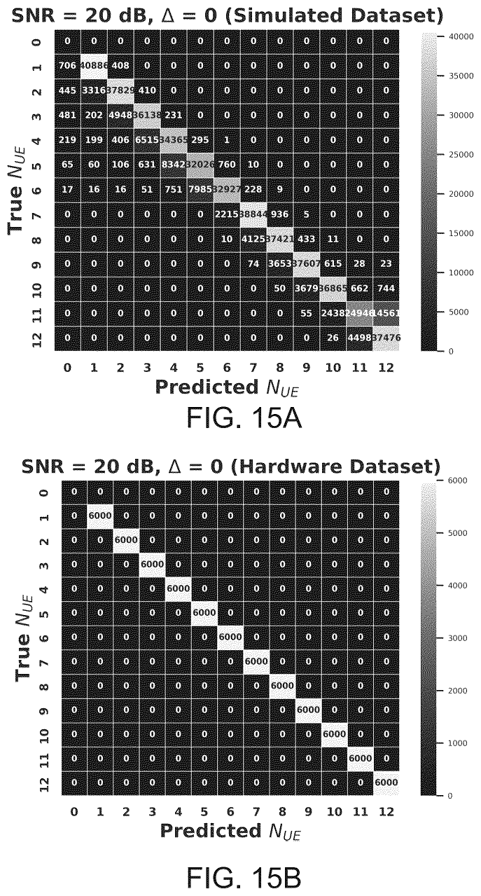

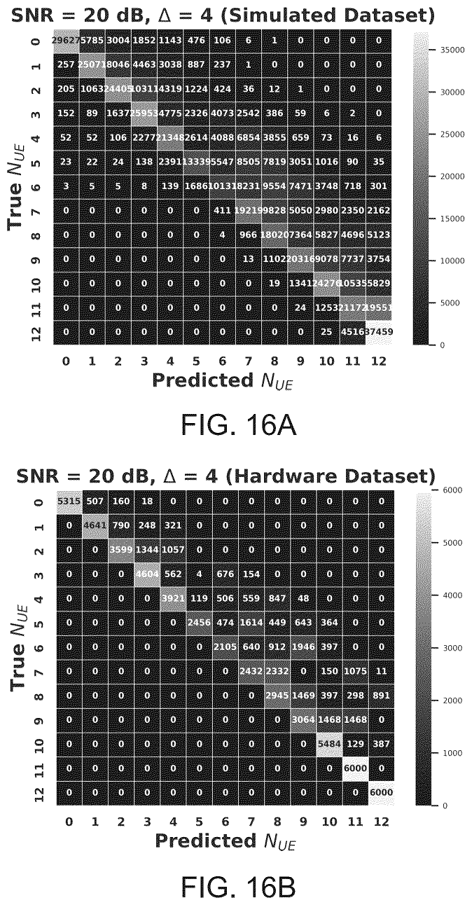

FIGS. 13 and 14 show confusion matrices for the number of multiplexed UEs for both simulated data and hardware-captured data at an SNR of 0 dB and Δvalues of 0 and 4 respectively. FIGS. 15 and 16 show confusion matrices for the number of multiplexed UEs for both simulated data and hardware-captured data at an SNR of 20 dB and Δvalues of 0 and 4 respectively. We notice that all the confusion matrices for the prediction of the number of multiplexed UEs are largely diagonally dominant. Furthermore, for any SNR, when Δ=0, the error in the predicted number of UEs fluctuates between +1 and −1 in the majority of instances, confirming the high accuracy values in FIGS. 9A and 9B. As A increases, the error tends to grow on the positive side, meaning that the NN model predicts more UEs than actually present. As stated above, the overprediction is due to the fact that A is always positive.

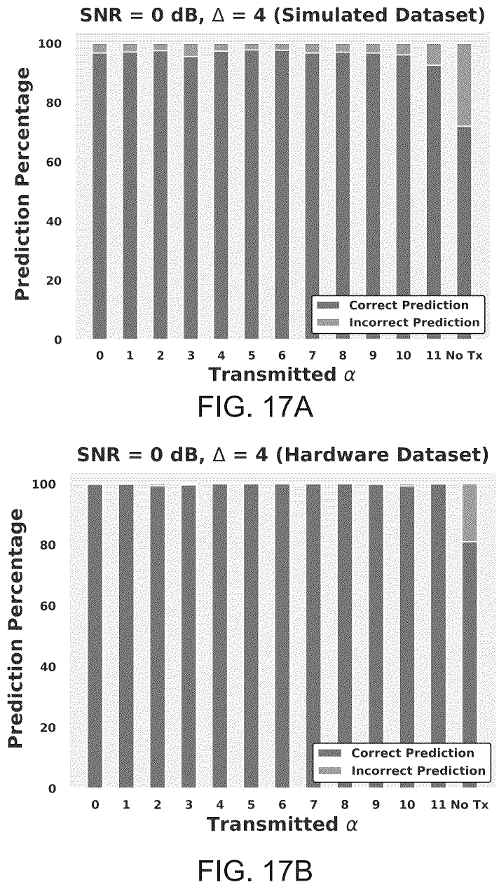

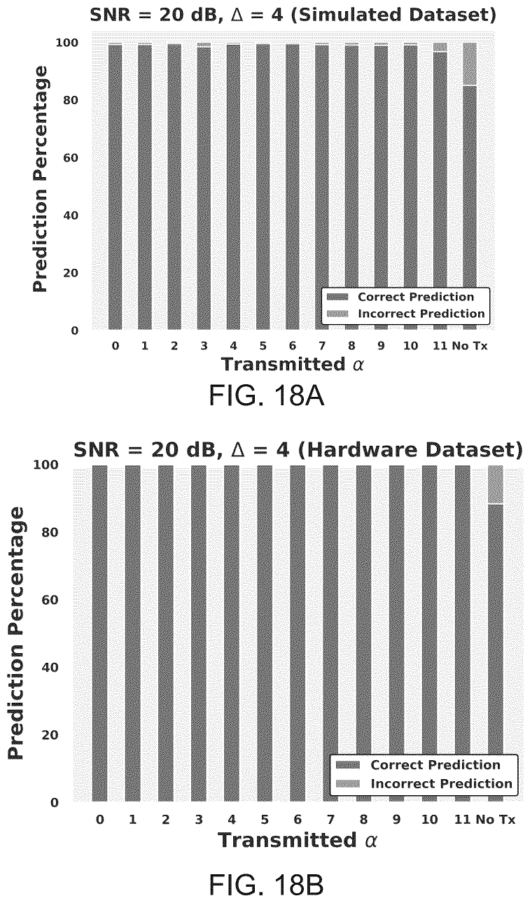

The column charts in FIGS. 17 and 18 show the percentage of correct and incorrect predictions for the transmission of every a from 0 through 11. The result of the NN model's prediction for the scenario where a particular α has not been transmitted by any UE is also captured in the last column labeled NoTx. Correct prediction in the last column indicates that the model was able to correctly identify the non-transmission of a particular α value, and incorrect detection determines the instances where a particular α has not been transmitted but incorrectly predicted. From FIGS. 17 and 18, it is evident that the NN model is not biased towards any particular α and the cyclic shifts are correctly identified in the majority of instances. FIG. 20 shows that the model generalizes well across multiple doppler values as it presents significant increase in performance for the entire range against the conventional method.

Implications of Model Performance on a 5G System: In general, both false detections and missed detections are detrimental to PUCCH Format 0 performance. However, from the context of sustaining a communication link between a gNB and a UE, a small number of false detections are more tolerable than missed detections. For example, when a gNB falsely detects a Scheduling Request, it allocates a small uplink bandwidth to the UE. Since the UE actually does not have any valid data to transmit, it would populate the uplink packet with padding information and indicate its lack of data in the Buffer Status Report (BSR). No further uplink grants will be allocated to the UE. On the other hand, if a gNB misses the detection of an ACK, it will assume that the prior downlink transmission was not decoded by the UE. In this scenario, a significant downlink bandwidth will be allocated to the UE for the retransmission. Successive missed detection of ACKs will lead to the termination of the radio link (referred to as Radio Link Failure) between the gNB and the UE. Hence, occupying a small uplink bandwidth (due to false detection of an SR) is preferable to occupying a large downlink bandwidth (due to missed detection of ACKs) since recovery from a Radio Link Failure (RLF) involves heavy signaling for the UE to reattach.

As shown in FIGS. 12, 14 and 16, at low SNRs or high Δvalues, the proposed UCINet0 tends to overpredict the number of UEs actually present, rather than underpredict. This shows that the model, even when it makes a wrong prediction, is good at avoiding scenarios leading to RLFs.

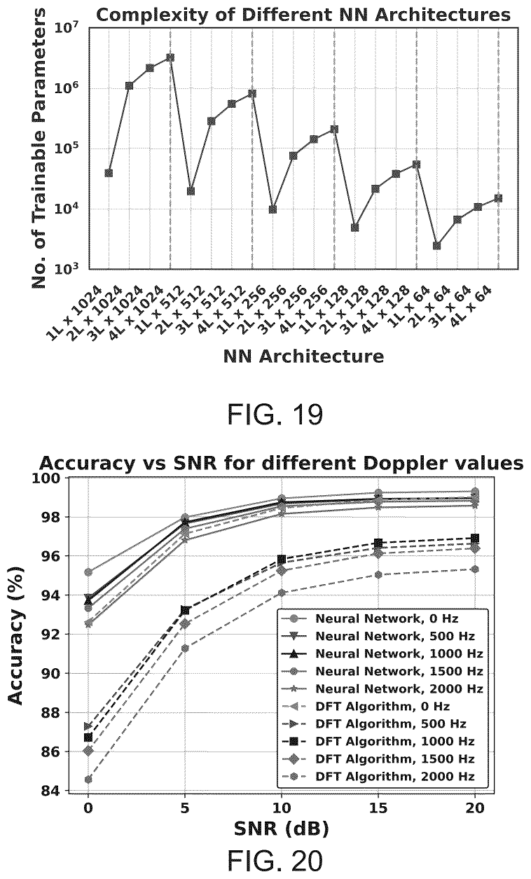

Model Complexity Analysis: FIG. 19 shows the number of trainable parameters for different FCN architectures. These parameters increase with the number of layers and neurons. The number of trainable parameters increases with the number of layers and neurons. An increase in the number of trainable parameters leads directly to an increase in the latency incurred due to fetching the weights from memory and neural network computations. Current 5G systems function with fundamental time units on the order of hundreds of microseconds. To cater to this requirement, the processing of all the physical layer channels allocated to each user must be completed in a duration of the order of tens of microseconds. For example, in our 5G Testbed, we use a subcarrier spacing of 30 kHz, which translates to a slot duration of 500 μs. Hence, the physical layer processing of all the users allocated in that slot needs to be completed within this time frame. If 10 PUCCH Format 0 instances are allocated in an uplink slot, each of them should be processed in no more than 50 μs. This time constraint also applies to AI/ML-based approaches such as neural networks. Hence, FPGAs are a promising choice for hardware implementation of such time-constrained neural networks.

In order to deploy a version of UCINet0 on hardware devices such as FPGAs, the trade-offs between model performance as shown in FIG. 7 and model complexity as shown in FIG. 19 must be considered. These two parameters help us choose the best suited model based on the available memory and compute resources on the hardware. The memory and bandwidth requirements for storing and retrieving the weights of Neural Networks like UCINet0 can be met by Xilinx's latest Versal series FPGAs, which contain AI engines to perform matrix multiplications efficiently.

We claim:

1. A system for feedback signaling in wireless communication, comprising:
at least one User Equipment (UE) configured to receive at least one downlink transmission that requires acknowledgement; and
a base station, configured to receive the Uplink Control Information (UCI) carried by the PUCCH Format 0 for decoding, the base station comprising a multi-label neural network classifier.

2. The system of claim 1, wherein the base station is configured for downlink transmission which is to be received by a UE.

3. The system of claim 1, the multi-label neural network classifier comprising:
an input layer containing 12 or more neurons configured to receive 12 or more real or complex sequence inputs or 24 neurons configured to receive 24 real sequence inputs and an additional optional input for metadata;
one or more dense layers, containing 64 or more neurons; and
an output layer containing 12 or more neurons representing up to 12 phase rotation (α) values of the multiplexed users.

4. A method for decoding UCI wireless communication, comprising:
providing a multi-label neural network classifier to serve as a generalized PUCCH Format 0 decoder;
generating a dataset for training the decoding model;
initializing the decoding model;
training the decoding model;
testing the decoding model;
receiving the input PUCCH Format 0 signal and associated metadata of a number of users N_{UE};
feeding the signal to the decoding model;
predicting N_{UE} phase rotation values corresponding to at least some; and
obtaining α values.

5. The method of claim 4, wherein providing the multi-label neural network classifier comprises providing:
an input layer containing 12 or more neurons configured to receive 12 or more real or complex sequence inputs or 24 neurons configured to receive 24 real sequence inputs and an additional optional input for metadata;
one or more dense layers, containing 64 or more neurons; and
an output layer containing 12 or more neurons representing up to 12 phase rotation (α) values of the multiplexed users.

6. The method of claim 4, wherein providing the multi-label neural network classifier comprises providing:
an input layer containing 25 neurons configured to receive 24 real sequence inputs and the metadata as 25^{th} input;
three dense layers, each containing 256 neurons; and
an output layer containing 12 neurons configured to receive up to 12 phase rotation (α) values of the multiplexed users.

7. The method of claim 4, wherein generating the dataset for training includes one or both of:
collecting and storing waveform samples generated in a simulation software environment; or
collecting and storing real time received signal waveform samples from a live communication link.

8. The method of claim 6, wherein training the multi-label neural network classifier comprises running multiple epochs of training wherein each epoch is 1 pass of the entire training dataset through the decoding model.

9. The method of claim 8, wherein training the multi-label neural network classifier comprises running 150 or more epochs of training wherein each epoch is 1 pass of the entire training dataset through the decoding model.

10. The method of claim 4, wherein training the decoding model includes:
running multiple epochs of training wherein each epoch is 1 pass of the entire training dataset through the decoding model;
using a summation of waveforms resulting from multiplexed transmission by multiple transmitting entities;
using selected data conforming to a single (example: median) or multiple value(s) of SNR; and
dropping out randomly selected neurons and their connections with a certain probability during training.

11. The method of claim 10, wherein using a summation of waveforms includes the scenario where no entity transmits a signal.

12. The method of claim 4, comprising performing the training on a same hardware on which the method is deployed, or on a different system.

13. The method of claim 4, wherein testing the decoding model includes providing upper bound value of the number of multiplexed users as the metadata input which is offset from the true value.

14. The method of claim 5, comprising pre-processing the signal prior to feeding.

15. The method of claim 4, wherein predicting comprises determining the N_{UE} phase rotation values α₀, α₁ . . . αN_{UE}−1 applied to the base sequence for classification.

16. The method of claim 15, wherein the obtaining includes obtaining either a single α value, multiple α values, or zero α values.

17. The method of claim 1, wherein receiving at the base station includes:
Hybrid Automatic Repeat Request (HARQ) acknowledgements for prior downlink transmissions;
Scheduling Request (SR) for the subsequent allocation of uplink transmission resources; and
Channel State Information (CSI) reports including channel quality metrics that facilitate link adaptation, precoding, and downlink resource allocation.

18. The method of claim 7, generating the dataset for training includes operating the transmitter or the receiver or both in a specific data collection mode to generate specific training sequences.

19. The method of claim 14, wherein the preprocessing comprises using one of Fourier Transform, correlation, scaling or absolute value squared to the input signal.
